(19) United States
(12) Patent Application Publication
(10) Pub. No.: US 2012/0237068 A1
(43) Pub. Date: Sep. 20, 2012

(54) Soft Concha Ring Behind-The-Ear Hearing Aid

(75) Inventors: Robert J. Fretz, Maplewood, MN (US); Vincent Joseph Mako, Lakeville, MN (US)

(73) Assignee: INTRICON CORPORATION, Arden Hills, MN (US)

(21) Appl. No.: 13/423,505

(22) Filed: Mar. 19, 2012

Related U.S. Application Data
(60) Provisional application No. 61/454,353, filed on Mar. 18, 2011.

(51) Int. Cl. H04R 25/00; H01R 43/00

(52) U.S. Cl. 381/330; 29/825

(57) ABSTRACT

A hearing aid has hearing aid electronics including the microphone, battery and amplifier in a behind-the-ear housing, with a flexible tube extending from the behind-the-ear housing to a concha-based suspension structure. The concha-based suspension portion is flexible and bears off a tragus contact area, an antitragus contact area and an antihelix contact area. Based on forces generated from these concha bowl contact areas, the tube is suspended in a centered position within the ear canal in an unoccluded fashion making little or no contact with the wall of the ear canal. An annulus of the suspension portion provides an open concha skin surface, which can naturally reflect sound down the generally open ear canal.

### CROSS-REFERENCE TO RELATED APPLICATION(S)

The present application claims priority from U.S. Provisional Application No. 61/454,353 entitled AFFORDABLE HEARING AID WITH SELF FIT EARPIECE, filed Mar. 18, 2011, incorporated herein by reference.

### BACKGROUND OF THE INVENTION

The present invention relates to hearing aids. In particular, the present invention pertains to the physical structure used to support the hearing aid relative to the ear of a user.

Hearing aids are electrical devices having a microphone to receive sound and convert the sound waves into an electrical signal, some sort of amplification electronics, and a speaker (commonly called a “receiver” in the hearing aid industry) for converting the amplified electronic signal back into sound waves that can be better heard by the user. The electronic circuitry is commonly powered by a replaceable battery.

Many different physical styles of hearing aids have been developed seeking to take best advantage of the advances in hearing aid electronics. Hearing aids were initially often bulky and body worn (in a shirt pocket, on spectacles, etc.). Over the years, great advances have been made both in the electronic circuitry and in the replaceable battery size. Today most hearing aids are worn and supported entirely by a single ear of the wearer. Some hearing aids have the primary electronics Behind-The-Ear (“BTE”), with most BTE designs having an acoustic tube which is mounted from a BTE receiver into the ear canal. The acoustic tube is typically secured in the ear canal by any of a variety of tips residing in the ear canal, with some of the tips being hard plastic custom shapes, and other tips being standard sizes with some flexibility or compressibility. Some ear canal tips also include a “wing” filament or spring which mates into the ear bowl, called the concha, to bias the tip into the canal. BTE hearing aids have been on the market for many years, and generally represent the least expensive class of hearing aid products in the current market. Another type of hearing aid, In-The-Ear (“ITE”) hearing aids are constructed with the primary electronics filling the user's concha. Even smaller devices, In-the-Canal (“ITC”) and Completely-In-the Canal (“CIC”) hearing aids, fit largely or entirely into the user's ear canal. Receiver-In-The-Ear (“RITE”) or Receiver-In-Canal (“RIC”) devices position most of the electronics behind the ear and then have a flexible tube or wire leading to a receiver positioned within the ear canal.

While there is generally a trend toward smaller and smaller hearing aid devices, the miniaturization of hearing aids poses certain problems. Smaller components are generally more expensive for a given performance level, and price of a hearing aid is very important for some consumers. As hearing aids get smaller, the distance between the sound outlet port and the microphone inlet port usually becomes smaller, resulting in a greater likelihood that sound output by the hearing aid will acoustically travel back to the microphone. Particularly in certain conditions when the amplified sound from the receiver is acoustically received by the microphone in a resonant frequency, the feed forward electronic gain in small hearing aids at desired gain levels can exceed the acoustic attenuation of the feedback sound. This can result in the production of undesirable feedback crackles and whistles during particular and difficult to predict acoustic and physical events.

Feedback cancellation algorithms available in modern hearing aid amplifiers help somewhat, particularly if the processing electronics operate on a digital signal in a digital signal processor (or DSP). Such feedback cancellation algorithms have been the subject of considerable technological research and advancement. Still, modern feedback cancellation algorithms may be unable to fully prevent oscillation at desired gain levels. Moreover the digital signal processors and the feedback cancellation algorithms add costs resulting in a more expensive hearing aid.

Another way many hearing aid manufacturers have attempted to combat feedback in small hearing aids is to have the hearing aid seal better into the ear canal, minimizing or eliminating the airborne path from the sound outlet port back to the microphone. For some ITE or ITC models, a resilient element such as a spring can be used to bias off anatomical structures in the user's outer ear, generally to push the hearing aid shell into tighter contact with the ear canal and perhaps simultaneously provide an out-of-the-canal structure used to pull the hearing aid out of the ear canal. Resilient or soft materials are also frequently used to make a more comfortable or tighter contact within the user's ear canal, such as a soft covering on the hard plastic shell to reduce the pressure points pressing against the user's ear canal. Regardless, physical blocking of the ear canal often reduces comfort of the wearer, at least in some situations (having a cold, riding an elevator, etc.), and can lead to an “occlusion” effect wherein the wearer feels like their ear is plugged and does not hear natural sounds as well.

Separate from the hearing aid field, ear plugs, ear pieces and sound protectors have been developed with the intent of minimizing the amount of natural sound which reaches the wearer's ear drum. While feedback may not be an issue with ear plugs and ear pieces (because they have no microphone), again the standard intent of fitting as tightly as possible into the ear canal can result in the “occlusion” effect. For instance, Surefire LLC of Fountain Valley, Calif. makes a variety of earplugs and communication systems earbuds which are usually intended to block out as much ambient noise as possible by sealing to the ear canal wall. For radio communication models which are intended to permit the passage of sound, a central lumen is formed through the ear canal portion 70 of the device.

Despite the great advances in hearing aid electronics, hearing aids are not universally worn by all who have some sort of hearing deficiency—far from it. It turns out that the actual programmable signal gain in the hearing aid is only a small part of the consumer's decision. In addition to how the hearing aid sounds, users are concerned with how the hearing aid looks, and with how the hearing aid feels. Many users want hearing aids which are as inconspicuous as possible. The hearing aid must fit comfortably, preferably remaining comfortable in a wide variety of conditions (differing health conditions of the wearer, changes in weather, changes in altitude, changes in headgear, etc.). However, physical blocking of the ear canal often reduces comfort of the wearer, at least in some situations (having a cold, riding an elevator, etc.). RITE, RIC and acoustic tube designs also have essentially two different insertion steps, one positioning and attaching the hearing aid electronics relative to the ear, and a second positioning and/or attaching the tube in the ear canal. The insertion process is particularly a problem for elderly users with dexterity limitations. Consistent fits on a day-to-day basis, requiring identical repositioning of the flexible tube and/or receiver, are hard to achieve.

Physical hearing aid designs should be as comfortable as possible to the wearer. The physical hearing aid designs should be pleasing visually, such as being as visibly inconspicuous as possible. The design should accommodate a large variety of ear anatomical shapes, allowing for easy insertion and removal. The physical hearing aid designs should also minimize feedback problems, while being provided at as low a cost as possible.

### BRIEF SUMMARY OF THE INVENTION

The present invention is a hearing aid having a concha-based structure for supporting an acoustic tube (or electrical tube for RIC structures) to a desired position relative to the ear canal of the wearer. Hearing aid electronics including the microphone and battery are in a BTE housing. The concha-based suspension portion is flexible and bears off a tragus contact area, an antitragus contact area and an antihelix contact area. Based on forces generated from these concha bowl contact areas, the tube is suspended in a centered position within the ear canal. The flexibility of the suspension portion at the contact areas ensures a comfortable fit. The annulus of the ring suspension portion provides an open concha skin surface, which can naturally reflect sound down the generally open ear canal.

### BRIEF DESCRIPTION OF THE DRAWINGS

FIG. 1 is an elevational side view of common ear anatomy.

FIGS. 2 and 3 are front and back perspective views of the hearing aid of the present invention, with the views taken about 135° relative to each other.

FIG. 4 is a side view showing the hearing aid of FIGS. 2 and 3 in the ear of FIG. 1.

FIG. 5 is a partial sectional view, in which the ear tissue is cut along line 5-5 and the concha portion of the hearing aid is shown in a bottom view.

While the above-identified drawing figures set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

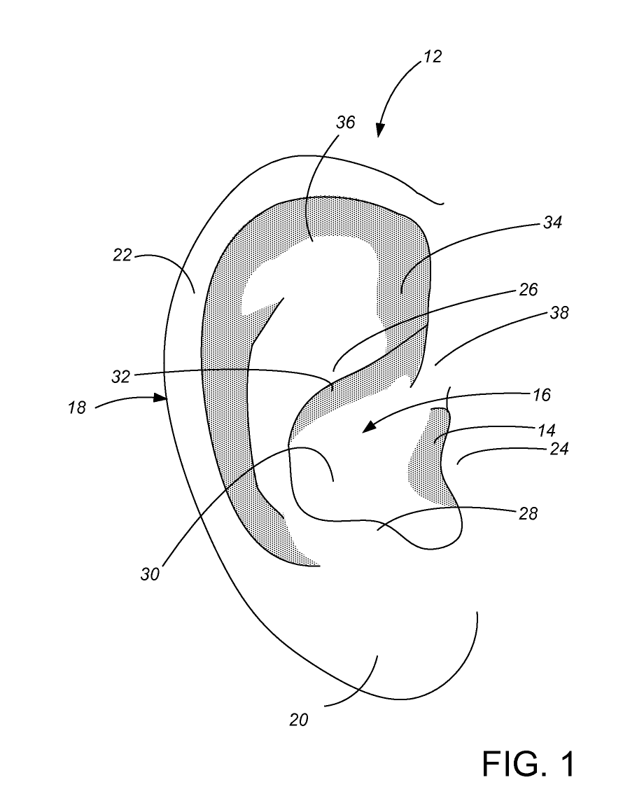

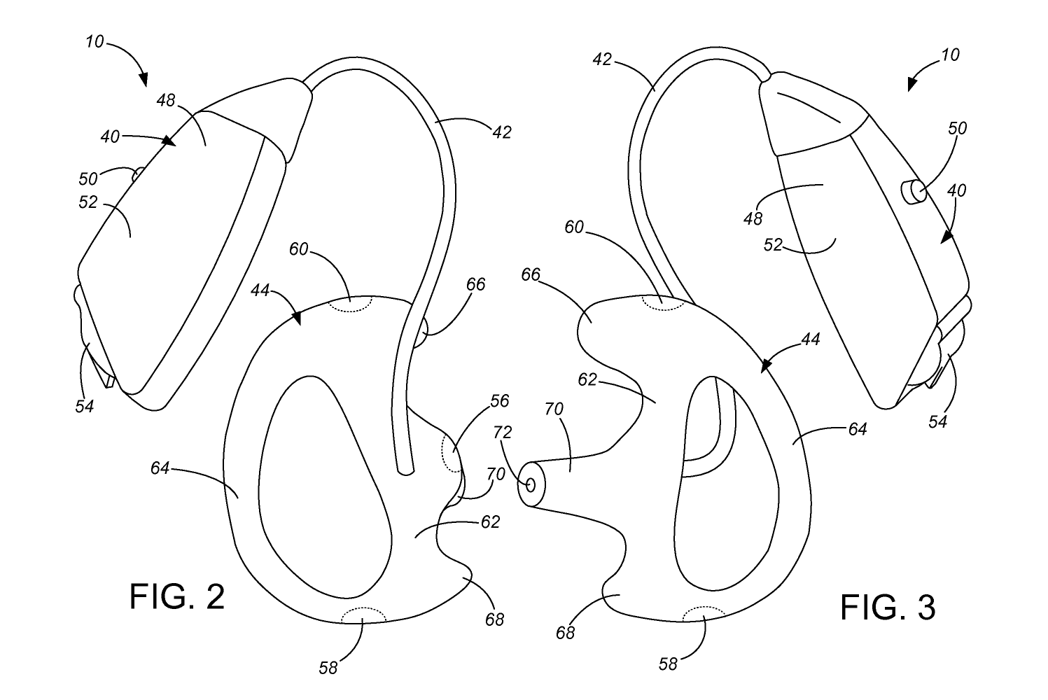

Shown in FIGS. 2-5, the present invention is a BTE hearing aid 10 used on an ear 12 of a user. While external ear anatomy is somewhat complex and can differ greatly from person to person, FIG. 1 depicts and identifies well-known external ear anatomy which is commonly shared among the vast majority of people. Hearing occurs at the base of the ear canal 14 which starts in the concha bowl 16. The human ear 12 includes a broad outer structure (called the pinna 18) which provides the ear lobe 20 (lobulus) and the helix 22. The ear canal 14 is partly obscured by the tragus 24. The concha bowl 16 lies between the ear canal 14 and the antihelix 26, with the antitragus 28 and the antihelix 26 slightly obscuring the edge of the concha bowl 16. The concha bowl 16 includes a lower portion known as the cavum conchae 30 and an upper portion known as the cimba conchae 32. The antihelix 26 extends around the cimba conchae 32 to a top portion known as the crus inferius antehelicis 34, and the helix 22 extends forwardly around the crus antehelicis 36 to just above the ear canal 14 terminating in the radix helices 38. The ear drum and other internal ear structure reside well down the ear canal 14. In an average adult, the ear canal 14 is about 26 mm long, with its central axis at a slightly forward angle to the plane generally established by the pinna 18 and concha 16, and with the central axis curving slightly. The ear canal shape (cross-sectional to its central axis) is largely circular or ovular, with an average cross section dimension (diameter) decreasing from about 9 to 7 mm.

Within the human population, the concha bowl 16 has much less variation in shape than ear canals 14. However, there is some variation in the concha size. That is, the distance between the tragus 24, antitragus 28 and the top of the antihelix 26 may be greater or smaller from individual to individual, but will maintain a generally consistent ratio, with the direction of the skin faces of the tragus 24, antitragus 28 and antihelix 26 being fairly consistent from person to person. The concha bowl 16, and particularly the side faces of the tragus 24, antitragus 28 and antihelix 26 defining the concha bowl 16, is more tolerant of pressure than the ear canal 14 or other internal ear structures.

As shown in FIGS. 2-5, the hearing aid 10 includes a BTE electronics portion 40, a tube 42 and a suspension portion 44. The present invention takes advantage of the more consistent concha bowl shape and higher pressure tolerance to mount, support and orient the tube 42 of the hearing aid 10. Generally speaking, most BTE and RIC hearing aids maintain tube position within the ear canal 14 by a frictional or compressive fit with the wall 46 of the ear canal 14.

The BTE electronics portion 40 includes a housing 48 which houses at least the microphone (not separately shown) and the battery (not separately shown), and preferably most or all of the other electrical components including a DSP chip (not separately shown) in digital implementations and a receiver (not separately shown) in sound tube implementations. During use, the BTE portion 40 is worn behind the user's pinna 18, at a height which is above the cimba conchae 32. Because one of the focal points of the preferred embodiment is its low cost, the electronic components within the housing 48 are preferably low in cost, and can be consistent with known prior art BTE hearing aids. For instance, the housing 48 may include a push button 50 or any other controls to assist in adjusting hearing aid settings. In the preferred embodiment, the housing 48 includes a shell 52 and a battery door 54. Both the shell 52 and the battery door 54 may both be molded from a polymer material such as acrylic, or any other traditional bio-compatible plastic material commonly used for hearing aid housings.

The tube 42 of the hearing aid 10 can be either a sound tube defining a lumen therethrough in cases wherein the receiver is in the housing 48, or can be an electrical tube in RIC cases. The tube 42 is curved and flexible, leading from the behind-the-ear location of the housing 48 into the ear canal 14. By being curved and flexible, the tube 42 can be easily adapted to fit essentially any size of ear distance between the behind-the-ear location of the housing 48 and the ear canal 14. If desired, the tube 42 can have a removable connection to the shell 52, so the tube 42 can be replaced separately from the BTE electronics portion 42 when needed.

The suspension portion 44 of the hearing aid 10 resides within the concha bowl 16. Through compressive forces against the concha skin surfaces, the suspension portion 44 supports, orients and positions the tube 42. The hearing aid structure of the present invention is not intended to significantly contact or press into the ear canal wall 46. To provide the suspension concept of the invention, the contact surfaces of the suspension portion 44 with the concha bowl 16 must be spread out over a substantial area. Essentially, the suspension portion 44 includes a tragus contact area 56, an antitragus contact area 58, and an antihelix contact area 60 (denoted in FIGS. 2, 3 and 5), each of which exert a mild compressive force against their corresponding skin surface. The function and relationship between the tragus contact area 56, antitragus contact area 58, and antihelix contact area 60 are similar to those discussed in U.S. patent application Ser. No. 12/895,012, published as U.S. Pat. Pub. No. 2011/0075871, owned by the assignee hereof and incorporated by reference. A generally vertical rib 62 extends between the tragus contact area 56 and the antihelix contact area 60. An arcuate rib 64 extends between the antitragus contact area 58 and the antihelix contact area 60, such that the suspension portion 44 has an overall shape like a D. The suspension portion 44 may include a top lobe 66 and a bottom lobe 68 projecting from the generally vertical rib 62.

At a mid-height in the vertical rib 62, a canal portion 70 extends out of plane relative to the D-shape, i.e., out of the plane defined by the tragus contact area 56, the antitragus contact area 58, and the antihelix contact area 60. The canal portion 70 is preferably frustro-conical in shape. In contrast to prior art ear plugs, the canal portion 70 should have a sufficiently small diameter that it makes little or no contact with the canal wall 46. Instead, the purpose of the canal portion 70 is to provide support for the tube 42, positioning the sound outlet port 72 centered in a suspended, cantilevered fashion within the ear canal 14. If the tube 42 is a sound tube, the lumen of the tube 42 extends through the canal portion 70 in air communication to the sound outlet port 72. If the tube 42 is an electrical connection in a RIC embodiment, then the receiver (not shown) is positioned in the canal portion 70 to output sound through the sound outlet port 72.

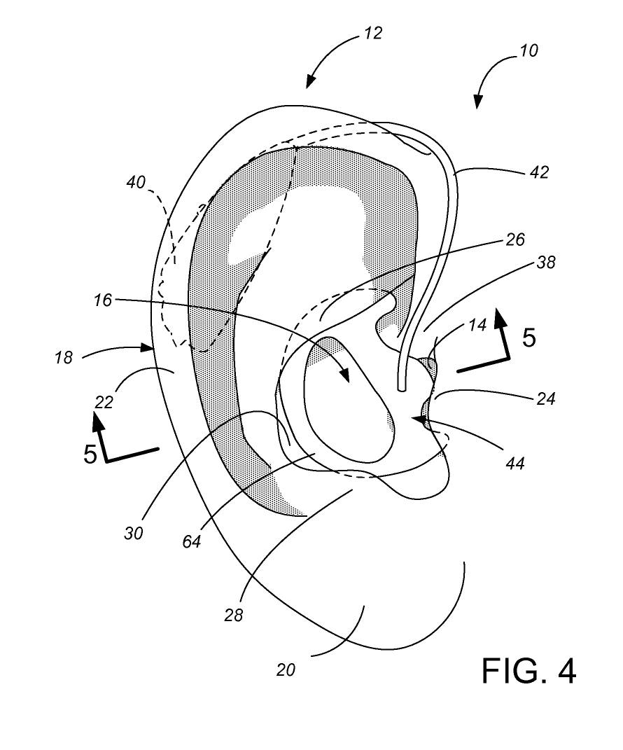

The tragus contact area 56, the antitragus contact area 58 and the antihelix contact area 60 need not have any identifiable marking on the hearing aid 10 to the wearer, but rather are denoted in the drawings merely to explain the operation of the structure within the concha bowl 16. The point of denoting the tragus contact area 56, the antitragus contact area 58 and the antihelix contact area 60 is not to suggest that the suspension portion 44 makes “point contact” with the concha skin or even necessarily makes contact at all at these specific points with any wearer's specific concha anatomy. Instead, the tragus contact area 56, the antitragus contact area 58 and the antihelix contact area 60 each conceptually represent a center point where a mild compressive force is exchanged between the suspension portion 44 and any wearer's concha anatomy. As shown in FIG. 4, the tragus 24, the antitragas 28 and the antihelix 26 all have an undercut that secures each of the tragus contact area 56, the antitragus contact area 58 and the antihelix contact area 60 in place.

The tragus contact area 56, the antitragus contact area 58 and the antihelix contact area 60 jointly define a base plane for the hearing aid 10, with the compressive force from the concha anatomy being generally directed inward in this base plane. The spacing between the tragus contact area 56, the antitragus contact area 58 and the antihelix contact area 60 allow the suspension portion 44 to remain generally stationary relative to the ear 12 even as the wearer accelerates, decelerates and turns his or her head this way and that. Moreover, the spacing between the tragus contact area 56, the antitragus contact area 58 and the antihelix contact area 60 all cause the hearing aid 10 to suspend the end of the tube 42 (and the receiver in RIC embodiments) in a relatively stationary location within the ear canal 14 without significantly biasing off any wall 46 of the ear canal 14. Much like three spaced legs of a stool can be used to support the seat, the forces from the tragus contact area 56, the antitragus contact area 58 and the antihelix contact area 60 can withstand gravitational and accelerational forces to hold the end of the tube 42 in an extended, cantilevered, suspended position centered in the ear canal 14, without contacting the wall 46 of the ear canal 14.

This concept of suspending the end of the tube 42 centered in the ear canal 14 based off biasing forces from the concha bowl 16 is very different from the bearing concepts of prior art BTE structures which bias off the ear canal 14 to hold the end of the tube 42 in place. This concept of suspending the end of the tube 42 centered in the ear canal 14 based off biasing forces from the concha bowl 16 is also very different from prior art concepts that occlude the ear canal 14.

The preferred suspension portion 44 is made from a generally soft and flexible polymer. For example, the suspension portion 44 can be formed of a resilient polymer commonly considered a rubbery material, such as having a durometer of less than about 90 on the Shore A scale, with the preferred rubbery material having a Shore A durometer of between 35 and 45, and most preferably a Shore A durometer of approximately 40. The preferred material for the suspension portion 44 is a medical grade, hypoallergenic, translucent PVC material, such as 3019-40/45 Clear 003, an injection-moldable flexible PVC compound with rubber like flexibility and softness available from AlphaGary of Leominster, Mass. This material has a specific gravity of 1.13 (ASTM D 792), a durometer A, 10 Second (⅛″/24 hr) value of 40/45, a durometer A, 10 Second (¼″/24 hr) value of 35/45 (both ASTM D2240), a tensile strength (75 mil) of 1200 psi, an elongation (75 mil) of 525%, and a modulus 100% (75 mil) of 340 psi (all ASTM D 638). When a mild compressive force is delivered in the base plane for the hearing aid 10 on each of the tragus contact area 56, the antitragus contact area 58 and the antihelix contact area 60, the suspension portion 44 should substantially compress or deflect relative to the compression or deflection of the tissue itself. Numerically, the flexibility between the tragus contact area 56, the antitragus contact area 58 and the antihelix contact area 60 should be about 200 N/m or less over the first millimeter or two of deflection.

The tube 42 is joined to the suspension portion 44 such as with an epoxy adhesive. Alternatively, the tube 42 can be axially inserted into a hole in the suspension portion 44, or the suspension portion 44 can be formed with a mating slit attachment configuration, wherein the tube 42 can be pressed into the slit and pulled from the slit if desired to fit with a different concha ring structure. The tube 42 can include orientation knobs (not shown), which mark the location wherein the tube 42 enters and exits the suspension structure 44. As another alternative, the tube 42 can be molded insitu into the suspension portion 44.

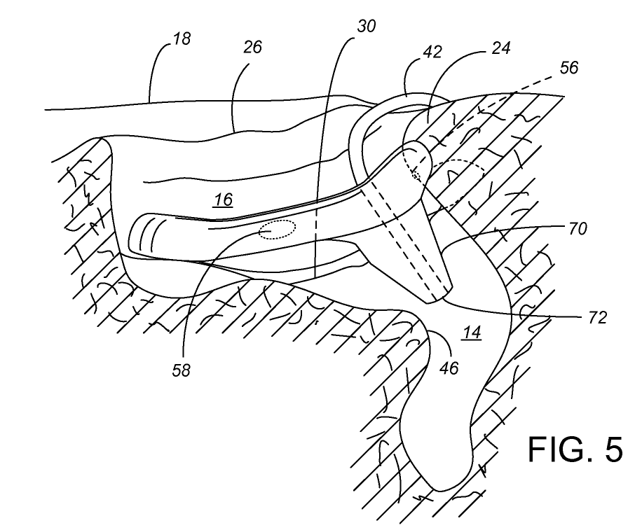

As noted, the hearing aid structure of the present invention is not intended to significantly contact or press into the ear canal wall 46, best shown with reference to the cross-sectional shape of FIG. 5, which depicts a cross-sectional cut through tissue taken across the ear canal 14 when the hearing aid 10 is being worn, but showing the suspension structure 44 in side view. The sound outlet port 72 is in the ear canal 14, with the distal end of the canal portion 70 being much smaller than the canal diameter. This results in very minimal or no contact with the canal wall 46. The central axis of the canal portion 70 extends at a slight angle (typically 10-20°) to the base plane defined by the tragus contact area 56, the antitragus contact area 58 and the antihelix contact area 60.

The preferred dimensions of the suspension portion 44 are sized to mate into common concha dimensions. The depth of the sound port 72 relative to the plane defined by the tragus contact area 56, the antitragus contact area 58 and the antihelix contact area 60 is between 5 mm and 25 mm, and more preferably at a height between 10 mm and 15 mm, such that the sound port 72 is at a depth between ⅓ and ⅔ of the standard depth of most ear canals 14. The preferred depth of the sound port 72 relative to the base plane is about 13 mm. To provide the stable suspension forces for the canal portion 70, each of the tragus contact area 56, the antitragus contact area 58 and the antihelix contact area 60 should be between 10 and 30 mm apart. The distance between the tragus contact area 56 and the antitragus contact area 58 is the shortest of the three distances in the base plane, between 10 mm and 20 mm. In the preferred embodiment, the distance between the tragus contact area 56 and the antitragus contact area 58 is about 14 mm. The distance between the antihelix contact area 60 and the antitragus contact area 58 is the longest of the three distances in the base plane, between 20 mm and 30 mm. In the preferred embodiment, the distance between the antihelix contact area 60 and the antitragus contact area 58 is about 26 mm. The distance between the antihelix contact area 60 and the tragus contact area 56 is between 15 mm and 25 mm, with a preferred dimension of about 20 mm. These preferred dimensions provide for the suspension of the canal portion 70 within the ear canal 14 as being cantilevered from the base defined by the concha bowl 16.

While there is little variation in shape, there is some variation in the concha size among the human adult population. The generally arcuate rib 64 can bend slightly to accommodate a fairly wide range of concha bowl sizes. Further, the preferred dimensions can easily be modified to fit a wider range of different concha sizes, such as a large version with dimensions 10% greater than the preferred dimensions given and a small version with dimensions 10% smaller than the preferred dimensions given. The differently sized versions can be provided as part of a kit so the customer can select which suspension portion 44 fits best out of the kit. Another alternative is to design suspension portion 44 with a means to adjust its size. One way to adjust the size of the suspension portion 44 is to create joints in the ring where added length can be inserted, such as in the arcuate rib 64 between the antihelix contact area 60 and the antitragus contact area 58. Another means to adjust the size of the suspension portion 44 is to provide elements attachable to the edges of the ring to increase the dimensions between the tragus contact area 56, the antitragus contact area 58 and the antihelix contact area 60. Another strategy to adjust the size of the suspension portion 44 is to have elements which can be trimmed off the ring to reduce the dimensions between the tragus contact area 56, the antitragus contact area 58 and the antihelix contact area 60. Either by providing different sizes of suspension portion 44 or by having the size of the suspension portion adjustable, the fitting of the suspension portion 44 should be able to be accomplished by a user without assistance from an audiologist or other experienced professional. Self-fitting/self-selection of the suspension portion 44 significantly reduces the cost of the hearing aid 10 relative to the cost of taking a customized ear mold or professional fitting of the physical hearing aid structure.

The end of the tube 42 does not make contact with the wall 46 of the ear canal 14, such that skin on concha side of the ear canal 14 continuously flows without contact by the hearing aid 10 to the concha face. The separation distance between the end of the tube 42 and the skin is usually about 2 to 3 mm.

The face of the concha bowl 16 itself is preferably left open and not covered by the suspension portion 44 of the hearing aid 10. The annular opening in the suspension portion 44 provides several benefits. By having the annular suspension portion 44, sound is received by the majority of the concha skin surface in a more natural way than most ITE hearing aids which cover the concha face. Because the majority of the space within the ear canal 14 is open, sound received on the concha skin surface is reflected down the ear canal 14 in a more natural way than possible with most BTE, ITC and CIC designs.

In some designs, a fully continuous ring for the suspension portion 44 may not be necessary. However, the preferred suspension structure 44 borrows from the ear plug designs of Surefire LLC to include not only a complete ring, but also the top lobe 66 and bottom lobe 68 to more securely hold the suspension structure relative to the concha bowl 16. U.S. Pat. No. 7,394,910 of Surefire LLC is incorporated by reference. Regardless, the important consideration is the layout and relative flexibility of the tragus contact area 56, the antitragus contact area 58 and the antihelix contact area 60, with or without a full ring structure and with or without the top and bottom lobes 66, 68. Moreover, unlike the ear plug designs of Surefire LLC, any ear canal portion 70 of the suspension structure 44 must be small enough so it does not make substantial contact with the ear canal skin, but rather suspends the end of the tube 42 in a cantilevered, suspended position in the middle of the ear canal.

It can thus be seen that the suspension portion 44 can be readily adapted over a fairly wide range of concha sizes and structure, but without generating uncomfortable forces on the concha 16 or the ear canal 14 of the wearer. Even if the canal portion 70 comes into contact with the ear canal 14 (as can happen during insertion of the hearing aid 10 into the ear 12, but also could happen if suspension portion 44 is not properly oriented and seated in the concha 12 or if the shape of the wearer's ear canal 14 was drasticly out of norm), only a minimal force will be placed on the wall 46 of the ear canal 14. The concha ring design of this hearing aid 10 is thus more comfortable than traditional designs that have the sound tube held into place through contact with the ear canal 14. The concha bowl 16 has much less variation in shape than ear canals 14, and the concha bowl 16 is more tolerant of pressure points than the ear canal 14.

The suspension portion 44 design is also easy and intuitive for the user to put into place. The suspension portion 44 is relatively easy to grasp and makes it relatively easy for the user's fingers to manipulate the location and orientation of the suspension portion 44 when inserting the suspension portion 44 into the user's concha 16. The suspension portion 44 is also relatively easy for the user to grab when the user's desires to remove the hearing aid 10 from his or her ear. The suspension portion 44 leads to a very consistent positioning of the sound tube 42 relative to the user's ear canal 14 over multitudes of insertions and removals, always locating the sound port 72 at the same depth in the ear canal 14, leading to a more consistent performance of the hearing aid 10.

The sound outlet port 72 is located a considerable distance away from the BTE portion 40 that holds the microphone. This separation significantly reduces acoustic feedback in the hearing aid 10. The hearing aid 10 can be manufactured at a relatively low cost while still providing good feed forward gain. If desired, the BTE portion 40, the tube 42 and/or the suspension portion 44 can be made as separate components which are assembled by the user, enabling both low cost replacement of components and separate, user-selected sizing. Importantly, the hearing aid 10 can be fully sized and configured by a user without the assistance of an audiologist or other hearing aid professional, further lowering the cost of the hearing aid 10 to the average consumer.

Although the present invention has been described with reference to preferred embodiments, workers skilled in the art will recognize that changes may be made in form and detail without departing from the spirit and scope of the invention.

What is claimed is:

1. A hearing aid comprising:
a behind-the-ear portion including a housing containing hearing aid electronics, the hearing aid electronics at least a microphone and a hearing aid amplifier receiving a signal from the microphone;
a ring suspension portion having three areas of concha contact, such that the ring suspension portion can be held in place in a user's ear by contact with three main points of concha anatomy, the ring suspension portion having substantial flexibility between the three areas of concha contact;
a flexible tube leading from the behind-the-ear portion to the ring suspension portion such that a sound outlet port of the hearing aid is positioned at a central location within the user's ear canal, an end of the flexible tube being cantilevered in a suspended position within the user's ear canal with forces from the three areas of concha contact of the ring suspension portion.

2. The hearing aid of claim 1, wherein the ring suspension portion is adjustable in size.

3. The hearing aid of claim 1, wherein the ring suspension portion forms a complete circle defining a central concha opening for exposing a central portion of the user's concha.

4. The hearing aid of claim 1, wherein the ring suspension portion is formed of a translucent material.

5. The hearing aid of claim 1, wherein the ring suspension portion further has a canal portion extending to be received in the user's ear canal, the canal portion being smaller than the canal dimensions so as to have minimal or no contact with the canal wall.

6. The hearing aid of claim 5, wherein the canal portion is frustro-conical in shape, with an opening therethrough which receives the tube.

7. The hearing aid of claim 1, wherein the ring suspension portion is formed of a rubbery material having a durometer of less than about 90 on the Shore A scale.

8. The hearing aid of claim 1, wherein the ring suspension portion provides a stiffness of 200 N/m or less over the first millimeter of deflection between the areas of concha contact.

9. The hearing aid of claim 1, wherein the three areas of contact comprise a tragus contact area, an antitragus contact area and an anti-helix contact area, wherein the ring suspension portion has a central concha opening for exposing a central portion of the user's concha.

10. The hearing aid of claim 9, wherein the distance between the tragus contact area and the antitragus contact area is between 10 mm and 20 mm, wherein the distance between the antihelix contact area and the antitragus contact area is between 20 mm and 30 mm, and wherein the distance between the antihelix contact area and the tragus contact area is between 15 mm and 25 mm.

11. The hearing aid of claim 10, wherein the ring suspension portion forms a complete circle defining a central concha opening for exposing a central portion of the user's concha, wherein the ring suspension portion further has a canal portion extending to be received in the user's ear canal, the canal portion being frustro-conical in shape and being smaller than the canal dimensions so as to have minimal or no contact with the canal wall, wherein the tube is a sound tube with a central lumen in air communication with the sound outlet port, the canal portion having an opening therethrough which receives the sound tube, the ring suspension portion being formed of a translucent rubbery material having a durometer of less than about 90 on the Shore A scale, such that the ring suspension portion provides a stiffness of 200 N/m or less over the first millimeter of deflection between the areas of concha contact.

12. A process of forming and assembling a hearing aid, comprising:
forming a selection of ring suspension portions to be received in a user's ear concha, each ring suspension portion having three areas of concha contact including a tragus contact area, an antitragus contact area and an anti-helix contact area, the selection of ring suspension portions having different sizes;
assembling electronics including at least a microphone and a hearing aid amplifier into a behind-the-ear shell; and
having a user select a ring suspension portion and assemble a flexible tube from the behind-the-ear shell to the ring suspension portion, such that when the user wears the hearing aid a sound outlet port of the hearing aid is positioned at a central location within the user's ear canal, an end of the flexible tube being cantilevered in a suspended position within the user's ear canal with forces from the three areas of concha contact of the ring suspension portion.

13. The method of claim 12, wherein the ring suspension portion forms a complete circle defining a central concha opening for exposing a central portion of the user's concha.

14. The method of claim 12, wherein the ring suspension portion is formed of a translucent material.

15. The method of claim 12, wherein the ring suspension portion further has a canal portion extending to be received in the user's ear canal, the canal portion being smaller than the canal dimensions so as to have minimal or no contact with the canal wall.

16. The hearing aid of claim 15, wherein the canal portion is frustro-conical in shape, with an opening therethrough which receives the tube, with an end of the tube being axially inserted by the user into the opening.

17. The hearing aid of claim 12, wherein the ring suspension portion is formed of a rubbery material having a durometer of less than about 90 on the Shore A scale.

18. The hearing aid of claim 12, wherein the ring suspension portion provides a stiffness of 200 N/m or less over the first millimeter of deflection between the areas of concha contact.

19. The hearing aid of claim 12, wherein the ring suspension portion has a central concha opening for exposing a central portion of the user's concha.

20. The hearing aid of claim 12, wherein the distance between the tragus contact area and the antitragus contact area is between 10 mm and 20 mm, wherein the distance between the antihelix contact area and the antitragus contact area is between 20 mm and 30 mm, and wherein the distance between the antihelix contact area and the tragus contact area is between 15 mm and 25 mm.
